(19) United States
(12) Patent Application Publication
(10) Pub. No.: US 2009/0005112 A1
(43) Pub. Date: Jan. 1, 2009

(54) Optical imaging system configurations for handheld devices

(75) Inventors: Noam Sorek, Zikhron-Yaakov (IL); Sharon Sade, Kfar-Yona (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 11/882,060

(22) Filed: Jul. 30, 2007

Related U.S. Application Data
(63) Continuation-in-part of application No. 11/819,961, filed on Jun. 29, 2007.

(51) Int. Cl. H04M 1/00; H04N 5/335

(52) U.S. Cl. 455/556.2; 348/294; 455/556.1; 348/E05.091

(57) ABSTRACT

A mobile communication terminal that comprises a body having a minimum bounding box with a wide dimension that includes an image sensor and an imaging unit. The body comprises an image-capture aperture substantially perpendicular to the wide dimension. The imaging unit is configured for imaging an image captured via said image-capture aperture on said image sensor.

### RELATIONSHIP TO EXISTING APPLICATIONS

This application is a continuation-in-part of pending U.S. patent application Ser. No. 11/819,961, filed Jun. 29, 2007, the contents of which are hereby incorporated by reference.

### FIELD AND BACKGROUND OF THE INVENTION

The present invention relates to an imaging unit for a handheld device and, more particularly, but not exclusively to an imaging unit, such as a camera, for a slim mobile communication terminal, such as a mobile phone.

In recent years, the demand for high performance compact digital imaging units has increased. Such imaging units convert an image of an intercepted scene to electronic signals by using an image sensor, such as a charge-coupled device (CCD) based sensor or a complementary metal-oxide semiconductor (CMOS) based sensor.

The image sensor comprises one or more electronics components including but not limited to a sensor array and an analog and/or a digital processing circuitry that is associated therewith. Optionally, the sensor array captures the light image in electronic form using thousands of photocells. The sensor array provides electrical signals proportional to the incident light at a portion thereof. These electrical signals are then processed into digital image data by the processing circuitry.

In particular, the demand for high performance compact digital imaging units, which are designed to be mounted in a compact device, such as a mobile phone, and have image sensors that have large number of pixels, more than two million pixels, is increasing. Such a demand is an outcome of the prevalence of mobile devices that incorporate digital cameras, such as laptops, webcams, mobile phones, personal digital assistants (PDAs) and the like.

An imaging unit that is designated for a mobile device is confined to strict dimensional limitations. Recently, the increased demand for slim mobile devices, such as mobile phones and PDAs, made the limitation of the imaging unit's depth even stricter.

In a standard optical design of an imaging unit, which is also known as a barrel configuration, a set of lenses are usually aligned along a common axis. In such an alignment, the set of parallel lenses are aligned between an image-capture aperture and a sensor having the same optical axis. In order to adjust the optical design to a thickness limitation of a slim mobile communication terminal, such as a mobile phone, the length of the optical track of the optical design is limited and therefore the focal distance of the imaging unit is limited. The thickness of such a telephone defines the possible focal distance of the used imaging device.

A number of solutions have been proposed for optical imaging for slim mobile devices. For example, U.S. Patent Application Publication No. 2003/0040346, published on Feb. 27, 2003 discloses a portable information terminal device having a camera feature and comprises a case provided with an image pickup module including a lens and an image pickup element and a lid member of the device provided at a predetermined position with an adapter optical system different from the lens. The lid member is linked to the case to be displaceable relative to the case between predetermined positions including a position for causing the optical axis of the lens and that of the adapter optical system to agree substantially with each other. When the optical axis of the lens and that of the adapter optical system are substantially agree with each other by displacing the case and the lid member relative to each other, the optical parameters of the synthetic optical system obtained by combining the lens and the adapter optical system are different from those of the lens.

Another example, disclosed in U.S. Pat. No. 7,139,473, published on Nov. 21, 2006 describes a mobile phone having a first casing that has a photosensor section for capturing an image, a second casing that has a lens section for projecting the image of a subject onto the photosensor section of the first casing and a connection section that foldably connects the first casing with the second casing. The photosensor section and the lens section are arranged so that the photosensor section and the lens section are superposed on each other in a state in which the first casing and the second casing are folded together. With this arrangement, the folding type camera device and the folding type portable telephone equipped with this device can be reduced in thickness.

### SUMMARY OF THE INVENTION

The present embodiments comprise a camera based mobile communication terminal, such as a mobile phone, with an image-capture aperture that is situated in the narrow side thereof and allows an integrated imaging unit, optionally with a folded optical axis, to capture an image. Optionally, the folded optical axis extends along the wide side of the mobile communication terminal. In such an embodiment, the thickness of the mobile communication terminal does not limit the focal length of the imaging unit of the mobile communication terminal.

Optionally, the body of the mobile communication terminal has a minimum bounding box with a wide and narrow dimensions and an image-capture aperture that is substantially perpendicular to the wide dimension of the minimum bounding box. Optionally, the wide side is the side that comprises the keypad and/or the screen of the mobile communication terminal.

The minimum bounding box may be defined with longitudinal, lateral, and vertical axes. The mobile communication terminal is thinner along the vertical axis than along the longitudinal axis or the lateral axis. One or more of the sides, which are in a plane that is parallel to the vertical axis, have an image-capture aperture. The mobile communication terminal further comprises an image sensor having a receiving element, such as a CMOS based sensor and an imaging unit for capturing an image of a scene via the image-capture aperture and projecting the first image on the receiving element. The imaging unit projects the image via an optical axis that is at least partly in a plane that is parallel or approximately parallel to the longitudinal or lateral axes of the mobile communication device. Optionally, the imaging unit is equipped with wide field of view (WFOV) lenses and small dimensions. As the optical axis that is formed by the imaging unit is at least partly in a plane that is parallel to the longitudinal and lateral axes of the mobile communication terminal, the focal length of the imaging unit may be kept relatively long. It should be noted that the focal length of the imaging unit may be kept relatively long even if the vertical axis of the mobile communication terminal may be relatively short, as described below.

In one embodiment of the present invention, the mobile communication terminal that comprises an image sensor with two or more regions, which are either different or equal in size, or an image-sensing integrated circuit (IC) with two or more sensing elements, such as image sensors. Such a mobile communication terminal comprises one imaging unit that projects an image of a scene on one of the regions and another imaging unit for projecting an image of a scene on another region. Optionally, both images are simultaneously projected on the image sensor. In such an embodiment, the image sensor is used for simultaneously capturing images of different scenes. The images may be taken in different resolutions, optionally from scenes at opposite or parallel sides of the mobile communication terminal.

In one embodiment of the present invention, one or more of the imaging units, which are used in the handheld device, are linear image-guiding units. Each linear image-guiding unit is a single block of a transparent material, such as transparent polycarbonate or glass, with diverting surfaces, which may be understood as diffractive, partly diffractive, refractive, and/or reflective surfaces. In one embodiment, a linear image-guiding unit is used for folding two or more different optics axes from two or more different scenes. Optionally, each one of the folded optics axes is projected on a different region of the image sensor.

According to one embodiment of the present invention, there is provided a handheld device, such as a mobile communication terminal, that comprises an image sensor having a receiving element facing a certain side of the handheld device and an imaging unit having an image pick-up element directed toward an opposing side. The imaging unit may comprise an imaging unit having a set of lenses and diverting elements or a linear image-guiding unit, preferably as described below. The imaging unit is configured for projecting an image that has been taken using the pick-up element on the image sensor. Such an embodiment allows, inter alia, folding the optical axis of the imaging unit in parallel to the depth of the image sensor. In such a manner, the handheld device may be slimmer than a handheld device with linear optical axis having the same length as the folded optical axis.

According to one embodiment of the present invention, there is provided a handheld device that comprises an image sensor, which is optionally mounted along one of the inner sides thereof, and an imaging unit having a path-diversion element. The imaging unit projects an image of a scene on the receiving side of the image sensor. An acute angle, which is less than 45° degrees, is formed between first and second rays sharing a common endpoint on the path-diversion element, the first and second rays respectively pass through the image sensor and the center of the scene.

The principles and operation of an apparatus and method according to the present invention may be better understood with reference to the drawings and accompanying description.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a schematic illustration of an exemplary mobile communication terminal with a linear optic unit, according to one embodiment of the present invention;

FIG. 1B is a schematic illustration of an exemplary clamshell mobile phone, according to one embodiment of the present invention;

FIG. 2 is a sectional illustration of the exemplary mobile communication terminal of FIG. 1A, according to one embodiment of the present invention;

FIG. 3 is a schematic illustration of an exemplary mobile communication terminal with an optic unit with a folded optical axis, according to one embodiment of the present invention;

FIG. 4 is a sectional illustration of the exemplary mobile communication terminal of FIG. 3, according to one embodiment of the present invention;

FIG. 5 is a schematic illustration of an exemplary mobile communication terminal, according to one embodiment of the present invention;

FIG. 6 is a sectional illustration of an imaging device having an image sensor with two regions, wherein each region receives an image projected by a different optical system, according to one embodiment of the present invention;

FIG. 7A is a schematic illustration of an exemplary mobile communication terminal with an imaging unit with a folded optical axis, according to one embodiment of the present invention;

FIG. 7B is a sectional illustration of the exemplary mobile communication terminal of FIG. 7A, according to one embodiment of the present invention;

FIG. 8A is a sectional illustration of a section of a mobile communication terminal having the imaging unit that is depicted in FIG. 7B and an additional imaging unit with a linear optical axis, according to one embodiment of the present invention;

FIG. 8B is a sectional illustration of a section of a mobile communication terminal having the imaging unit that is depicted in FIG. 7A and an additional imaging unit with a folded optical axis, according to one embodiment of the present invention;

FIG. 8C is another sectional illustration of a section of a mobile communication terminal having the imaging unit that is depicted in FIG. 7A and an additional imaging unit with a folded optical axis, according to one embodiment of the present invention;

FIG. 9 is a sectional illustration of a section of a mobile communication terminal having the linear imaging unit that is depicted in FIG. 6 and an imaging unit with a folded optical axis, according to one embodiment of the present invention;

FIG. 10A is a sectional illustration of a section of a mobile communication terminal having a linear image-guiding unit with a folded optical axis, according to one embodiment of the present invention;

FIG. 10B is a sectional illustration of a section of a mobile communication terminal having the linear imaging unit that is depicted in FIG. 6 and the linear image-guiding unit of FIG. 10A, according to one embodiment of the present invention;

FIG. 11 is a sectional illustration of a section of a mobile communication terminal having a linear image-guiding unit, according to one embodiment of the present invention; and

FIG. 12 is a sectional illustration of a section of a mobile communication terminal having a mechanical assembly with two linear image-guiding units, according to one embodiment of the present invention.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as necessarily limiting.

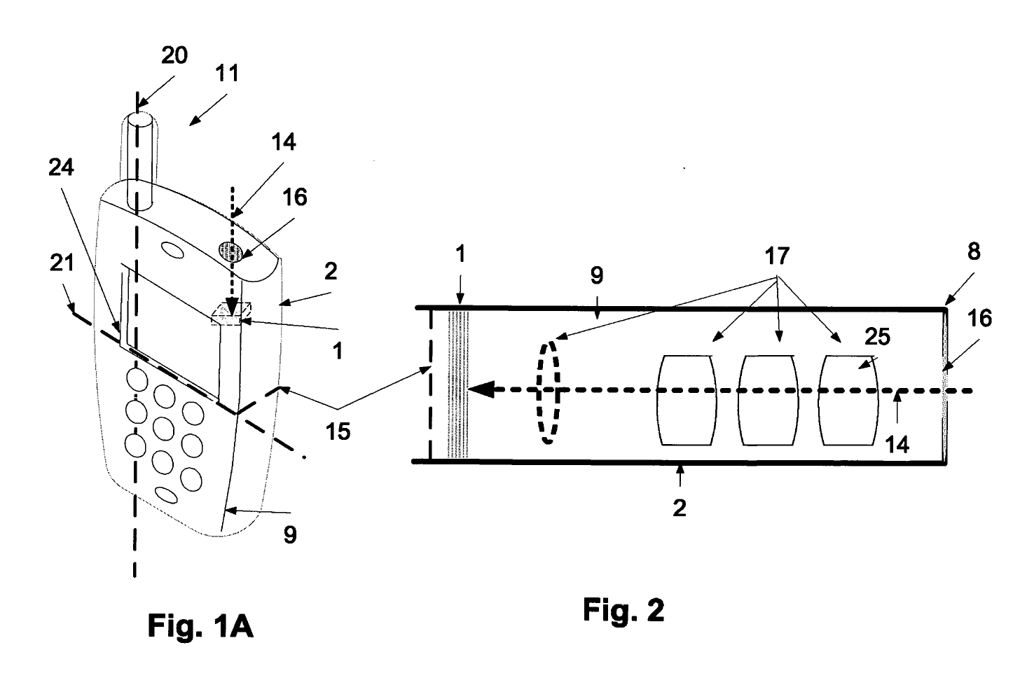

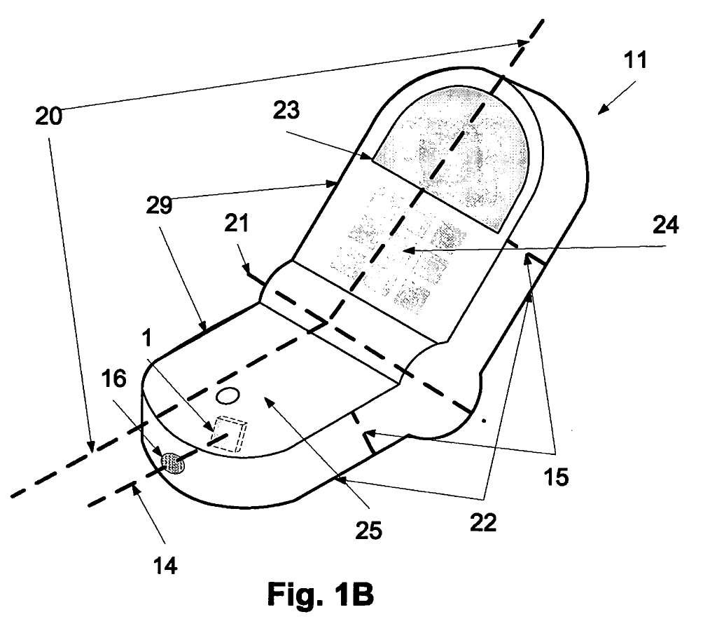

Reference is now jointly made to FIG. 1A, which is a schematic illustration of an exemplary handheld device 11, which is optionally a mobile communication terminal 11, such as a mobile phone, and to FIG. 2, which is a sectional illustration of a section of the mobile communication terminal 11, according to some embodiments of the present invention. FIGS. 1A and 2 depict a mobile communication terminal 11 with an imaging unit, such as a camera, that captures an image via an image-capture aperture 16 that is positioned in the narrow side thereof.

Optionally, the mobile communication terminal 11 is a PDA or a mobile phone such as, a cellular phone, a Smartphone, a dual-mode phone, or any other mobile communication terminal that is capable of providing information transfer between persons. The mobile communication terminal 11 has an image sensor 1, such as a CCD based sensor or a CMOS based sensor, optionally with a Bayer filter. Optionally, the image sensor 1 is a 0.5-inch diagonal image sensor.

The handheld device 11 comprises an imaging unit with a linear optical axis that may be referred to as a linear imaging unit, for example as shown at 22. The linear imaging unit 25 comprises an optical element, such as a lens, or a set of parallel optical elements 17, which are aligned along a common axis between the image sensor 1 and the image-capture aperture 16. Optionally, lenses may be cylindrical lenses, cylindrical lenses with aligned sides, as shown at FIG. 2, and the like.

The image-capture aperture 16 is situated in front of the image sensor 1 and optionally in parallel to the lateral axis of the mobile communication terminal 11, as shown at 21. Optionally, the linear imaging unit 25 is equipped with wide field of view (WFOV) lenses and small dimensions. It should be noted that an imaging unit with WFOV may be understood as an imaging unit with a field of view of more than 60 degrees width or a lens having width at least twice the height thereof. Optionally, the linear imaging unit 25 is equipped with one or more WFOV lenses. Optionally, the width of the linear imaging unit 25 as a whole is at least twice the height thereof. The width may be understood as the length of the linear imaging unit 25 along the longitudinal or the lateral axes and the height of the imaging unit 25 may be understood as the length of the imaging unit 25 along the vertical axis. Optionally, the dimensions of the linear imaging unit 25 are approximately 8 mm along the longitudinal and/or the lateral axes and approximately 3 mm along the vertical axis.

For clarity, the mobile communication terminal 11 defined with a minimum bounding box having wide and narrow sides. The capture aperture 16 is perpendicular to the wide side of the minimum bounding box. Optionally, the wide side is the side that comprises the keypad and/or the screen of the mobile communication terminal. In addition, a longitudinal axis of the mobile communication terminal 11 is understood as an axis that passes in parallel or substantially in parallel to one of the wide dimension of the mobile communication terminal 11, for example as shown by at 20. In addition, a lateral axis of the mobile communication terminal 11 may be understood as another axis that passes perpendicularly or substantially perpendicularly to the longitudinal axis, for example as shown at 21. A vertical axis of the mobile communication terminal 11 may be understood as an axis that passes in parallel or substantially in parallel to one of the narrow sides of the mobile communication terminal 11, for example as shown at 15.

In should be noted that the mobile communication terminal 11 is sized to be to be carried in a pocket size case and to be operated while the user holds it in her hands.

Element 2 denotes the rear side of the mobile communication terminal 11 and element 9 denotes the front side thereof. The front side may be understood as the side with the keypad and/or the screen and the rear side may be understood as a side that is opposite to a front side. The thickness of the mobile communication terminal 11 is defined the mobile communication terminal 11 along length the vertical axis, as shown at 15.

Optionally, in use, the linear imaging unit 25 projects an image of a scene on the receiving element of the image sensor 1. The scene has been captured in front of the image-capture aperture 16. As depicted in FIG. 2, the lenses 17 are aligned along a common optical axis 14, between the image-capture aperture 16 and the image sensor 1. In the depicted embodiment, the optical axis 14 is in a plane that is parallel to the longitudinal axis of the mobile communication terminal 11. Therefore, the length of the optical track is not confined to the length of the mobile communication terminal 11 along the vertical axis, as shown at 15, and the focal distance of the imaging unit 25 is not limited to the thickness of the mobile communication terminal 11.

Optionally, the imaging unit 25 comprises wide field of view (FOV) lenses that allow the design of an imaging unit, which is approximately 12-14 mm high and 7-8 mm wide. In such an embodiment, the height of the imaging unit 25 limits the thickness of the mobile communication terminal 11 only to more than 7-8 mm.

Optionally, the mobile communication terminal 11 includes a screen 24 with a viewing angle that allows the observer to see clearly a display of an image taken using the image sensor 1. In such an embodiment, the screen optionally allows the user see clearly the display from a point of view (POV) of more than 30° degrees from the center of the screen. In order to provide the user with such a viewing angle, the screen is optionally defined with high contrast ratio. For clarity, contrast ratio is defined as the ratio between the brightness of a white image and the brightness of a black image, which are displayed in the screen. Optionally, the optical orientation of the LCD elements of the screen directed toward the observer. Optionally, the angle between the line of sight of the observer, and the normal vector, which is a vector perpendicular to the screen, is adjustable. In such embodiment, the observer may change the angle of the screen 24 to an angle that allows her to watch clearly the display of an image taken using the image sensor 1.

Though the communication mobile terminal 11 in FIG. 1A is a mobile phone, the embodiments the present invention relates to PDAs, dual-mode phones, or any other mobile communication terminal that is capable of providing information transfer between persons.

However, FIGS. 1A, 3, and 5 depict a mobile phone 11 having a single straight plate with a screen and a keypad, the embodiments the present invention may relate to other mobile phones, such as slider mobile phones and clamshell mobile phones. For example, reference is now made to FIG. 1B, which is a schematic illustration of a clamshell mobile phone 11, according to embodiments of the present invention. For clarity, in clamshell mobile phone 11 the longitudinal axis of the mobile communication terminal 1 may be understood as the axis that passes in parallel or substantially in parallel to inner sides of the clamshell structure, for example as shown by at 20. In addition, a lateral axis of the clamshell mobile phone 11 may be understood as the axis that passes in parallel or substantially in parallel to a hinge that connects between the two sections of the clamshell mobile phone 11, for example as shown at 21. A vertical axis of the clamshell mobile phone 11 may be understood as an axis that passes in parallel or substantially in parallel to one of the narrow sides of the clamshell mobile phone 11 and perpendicularly or substantially perpendicularly to the lateral and longitudinal axes, for example as shown at 15. The wide dimension of the clamshell mobile phone 11 is the dimension of the screen 23 and/or the keypad 24 and the parallel dimension in the other section 25.

Element 22 denotes the rear side of the clamshell mobile phone 11, which is the side that faces the outside when the clamshell mobile phone 11 is folded and element 29 denotes the front side of the clamshell mobile phone 11, which is the side that faces is concealed when the clamshell mobile phone 11 is folded. The thickness of the clamshell mobile phone 11 may be understood as the length of the clamshell mobile phone 11 along the vertical axis 15.

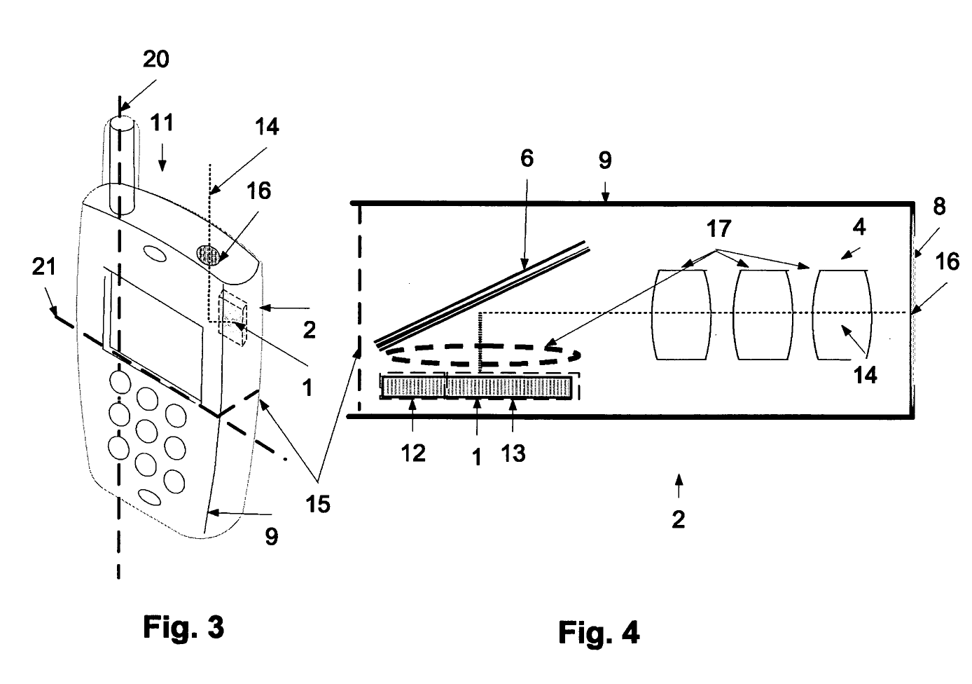

Reference is now made jointly to FIG. 3, which is a schematic illustration of an exemplary handheld device 11, which is optionally a mobile communication terminal 11, such as a mobile phone with an imaging unit with a folded optical axis and to FIG. 4, which is a sectional illustration of a section thereof, according to one embodiment of the present invention. The sides 2, 9, the axes 20, 21, the lenses 17, and the image sensor are as in FIG. 2. However, FIGS. 3 and 4 depict a handheld device 11 with an imaging unit with a folded optical axis 4, which may be referred to as a folded imaging unit.

Optionally, the folded imaging unit 4 comprises a set of optical elements, such as lenses, as shown at 17, and one or more path-diversion elements, as shown at 6, which outline a folded optical axis, for example as shown at 14. The path-diversion element 6 may comprise a reflective element, such as a mirror or a micro-electromechanical system (MEMS) mirrors unit, a refractive element, such as a collimating lens, a converging lens, or a prism, and a diffractive element, such as a diffractive grating, a fresnel lens, a zone plate, a hologram, or spatial light modulator.

Optionally, the MEMS mirrors unit is designed according to the principles which are described in Eugenie Dalimieret et al., Comparative analysis of deformable mirrors for ocular adaptive optics, Applied Optics Group, Department of Experimental Physics, National University of Ireland, Galway, Ireland, 30 May 2005, Vol. 13, No. 11 of optics express 4275, which is incorporated herein by reference.

Optionally, the folded imaging unit 4 comprises a linear image-guiding unit, as described below and depicted in FIGS. 6-8.

Optionally, the path-diversion element 6 is mounted in 45° degrees angle in relation to the image sensor 1 that is optionally mounted on the inner side the mobile communication terminal 11, optionally in parallel to the longitudinal axis thereof.

In such an embodiment, the optical elements 6, 17 are folded on top of one another to reduce the dimension of the imaging unit 4 along which the optical axis is folded. In such a manner, the effective length of the optical axis of the folded imaging unit 4, which may be understood as the zooming power of the handheld device or the mobile communication terminal 11, is increased without increasing the distance between the front and the rear sides of the mobile communication terminal 11. It should be noted that as the length of the optical axis increases, wider lenses, which may be more accurate, may be used.

Optionally, the folded optical axis 14 is designed to pass via an image-capture aperture 8 that is optionally situated in parallel to the vertical axis 15 of the mobile communication terminal 11, as shown at 10.

Optionally, the path-diversion element 6 is mounted in an acute angle, which is less than 450 degrees, in relation to the image sensor 1, which is optionally mounted onto the inner side one the front or rear side of the mobile communication terminal. In such an embodiment, the path-diversion element 6 is mounted in such an acute angle that less height is required in order to host the folded imaging unit 4. Therefore, the minimum depth of the mobile communication terminal 11, with respect to the folded imaging unit 4, may be even lower. Optionally, the optical elements 17 may also be mounted at an acute angle in relation to the image sensor 1.

The optics of the folded imaging unit 4 allows the positioning of the image sensor 1 in a parallel to the vertical axis 15 of the mobile communication terminal 11, for example as shown at FIG. 3. In such a manner, the image sensor 1 may be mounted in parallel to the rear and/or front sides of the mobile communication terminal 11. It should be noted that as the image sensor 1 is parallel to the vertical axis 15 of the mobile communication terminal 11, the body of the mobile communication terminal 11 may have a conic, a tubular, or a triangular cross-section shape.

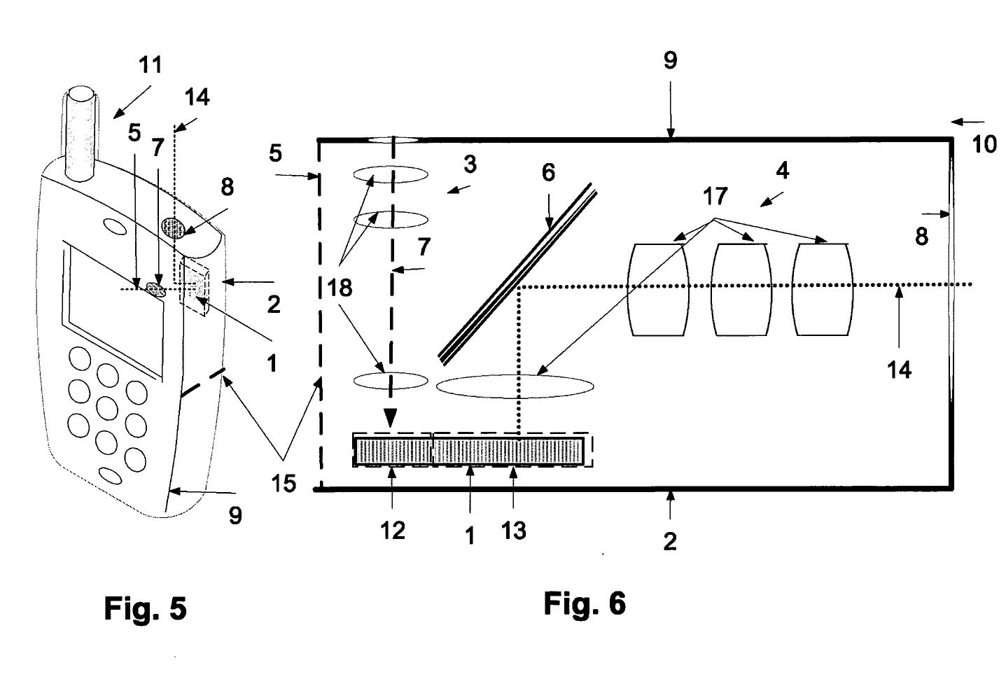

Reference is now made jointly to FIG. 5, which is a schematic illustration of an exemplary handheld device 11, such as the mobile communication terminal that is depicted in FIG. 4, and to FIG. 6, which is a sectional illustration of a section thereof, according to one embodiment of the present invention. The sides 2, 9, the axes 20, 21, the lenses 17, and the image sensor are as in FIG. 4. However, in the present embodiment, the front or the rear side may have a lower or an upper image-capture aperture 7 and the image sensor 1 of the handheld device 11 is divided to two regions 12, 13 or more. For example, one region 12 is designed according to the relatively low resolution of video graphics array (VGA) or quarter VGA (QVGA) standards, which are incorporated herein by reference and the other region 13 may be designed to capture a relatively high-resolution image, such as a 2-3 Megapixel image. Each region receives an image that is projected by a different imaging unit, for example 3 and 4, according to one embodiment of the present invention.

Optionally, at least one of the imaging units is a linear imaging unit, for example as shown at 3 that has a linear optical axis 5, which is parallel to the vertical axis 15. The linear imaging unit 3 comprises an optical element, such as a lens, or a set of parallel optical elements 18, which are aligned along a common axis between the image sensor 1 and the upper image-capture aperture 7. The upper image-capture aperture 7 is optionally situated in front of the image sensor 1, optionally in parallel to the rear or the front sides of the mobile communication terminal 11. Optionally, the linear imaging unit 3 projects an image of a scene on a first region 12 of the receiving element of the image sensor 1. The scene is captured in front of the upper image-capture aperture 7.

Optionally, at least one of the imaging units is a folded imaging unit with a folded optical axis, as shown at 4 and described above in relation to FIG. 4.

Optionally, the folded imaging unit 4 images an image of a scene, which has been captured in front of the image-capture aperture 14, on a second region 13 of the receiving element of the image sensor 1. As the image is projected only on a portion of the image sensor, the area of the diverting surface of the path-diversion element 6 may be smaller. In such an embodiment, the path-diversion element 6 may be shorter and therefore the thickness of the mobile communication terminal may be thinner.

The linear imaging unit 3 projects a first image of a first scene on one region 12 of the image sensor 1. The folded imaging unit 4 with the set of folded lenses 3 projects a second image of a second scene on another region 13 of the image sensor 1. In such a manner, the image sensor 1 may capture the first and the second images simultaneously or sequentially. When the images are captured in a sequential manner, slower electronics may be used.

Optionally, the pixel distribution along the receiving surface of the image sensor 1 is uniform. Optionally, the area of the first region 12 is smaller than the area of the second region 13, as depicted in FIG. 6. In such an embodiment, the resolution of the first image is lower than the resolution of the second image.

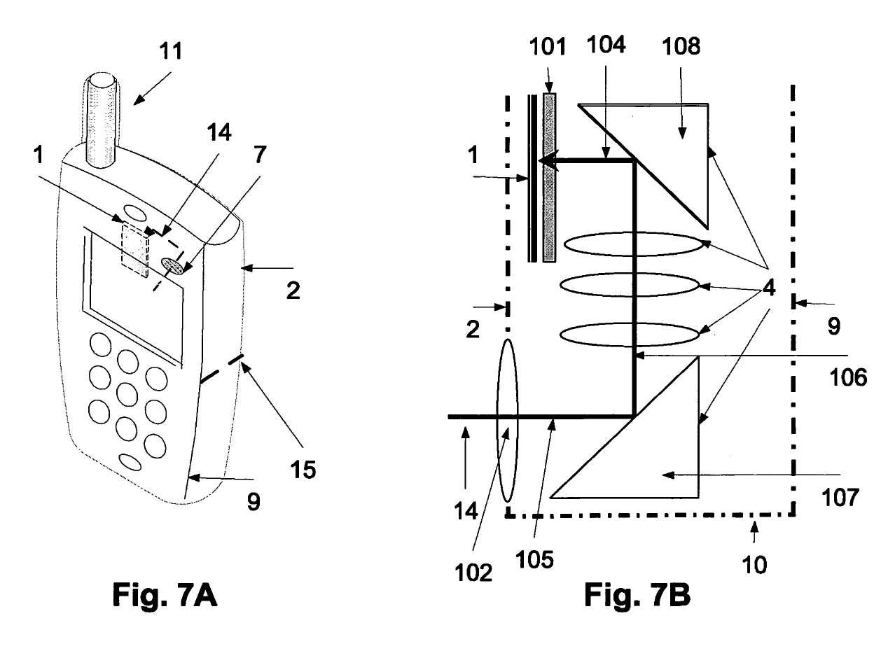

Reference is now made jointly to FIG. 7A, which is a schematic illustration of an exemplary handheld device 11, as depicted in FIG. 1A, with a folded imaging unit wherein the receiving side of the image sensor 1 and an image pick-up element 102 face opposite sides and to FIG. 7B, which is a sectional illustration of a section of the mobile communication terminal 11, according to one embodiment of the present invention. The image sensor 1, the linear imaging unit 3, and the rear and front sides 2, 9 of the mobile communication terminal 11 are as depicted in FIG. 6. However, the optics elements 107, 108, 17 of the folded imaging unit 4 and the arrangement thereof are different.

As described above, the image sensor 1 is mounted in parallel to the rear or the front sides of the mobile communication terminal 11, as shown at 2. Because of the position of the image sensor 1, the receiving side faces an opposite side of the mobile communication terminal 11, such as the side shown at 9. Optionally, an infrared (IR) cut filter is positioned in front of the receiving side of the image sensor 1. Optionally, the image sensor 1 comprises one or more photoelectronic transducer.

In FIG. 7B, the image pick-up element 102, which may be a converging lens, is situated in the front side 2 to which said image sensor 1 is parallel and/or attached. Optionally, the image pick-up element 102 and the image sensor may be situated in the rear side 9 of the mobile communication terminal 11. The configuration of the image pick-up element 102 and the folded imaging unit 4 allows the image sensor 1 to capture an image of a scene from a side opposing to the receiving side thereof. In such a manner, a portion of the folded imaging unit 4 and the image sensor 1, and optionally the processing circuitry thereof, are situated in a common plane that is parallel to one of the axes of the mobile communication terminal 11, preferably the longitudinal axis.

As described above, in standard optical design of an imaging unit, a set of lenses are usually aligned along a common optical axis. As the hosting handheld device has a limited thickness, using the standard optical design for an imaging unit with an image pick-up element that is situated in parallel to the front side of the hosting handheld device may be limited. Such an imaging unit may have a limited optical axis and a limited focal distance. In FIG. 7B, though the image pick-up element 102 is situated in a plane that is parallel to the longitudinal and lateral axes of the mobile communication terminal 11, the folded imaging unit 4 has a relatively long focal distance in relation to the thickness of the mobile communication terminal 11. Optionally, the perpendicular to the face of the receiving side of the image sensor 1 is parallel or approximately parallel to the plane of the vertical axis of the terminal communication terminal 11, as shown at 10. In such a manner, the focal distance of the folded imaging unit 4 is more than double the length of a standard optical design that passes in parallel to the vertical axis 15 of the terminal communication terminal 11 only once.

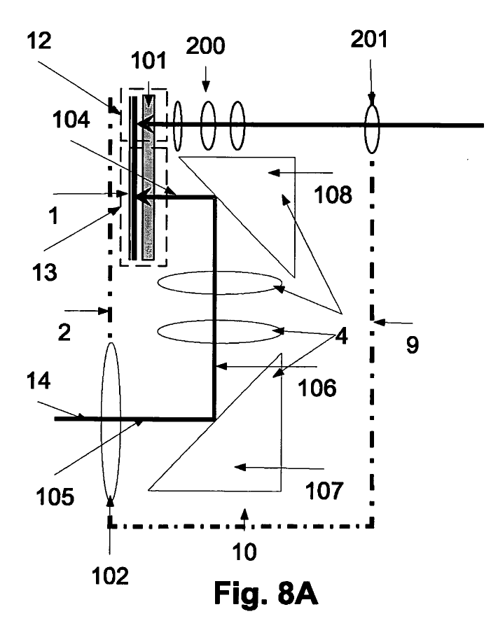

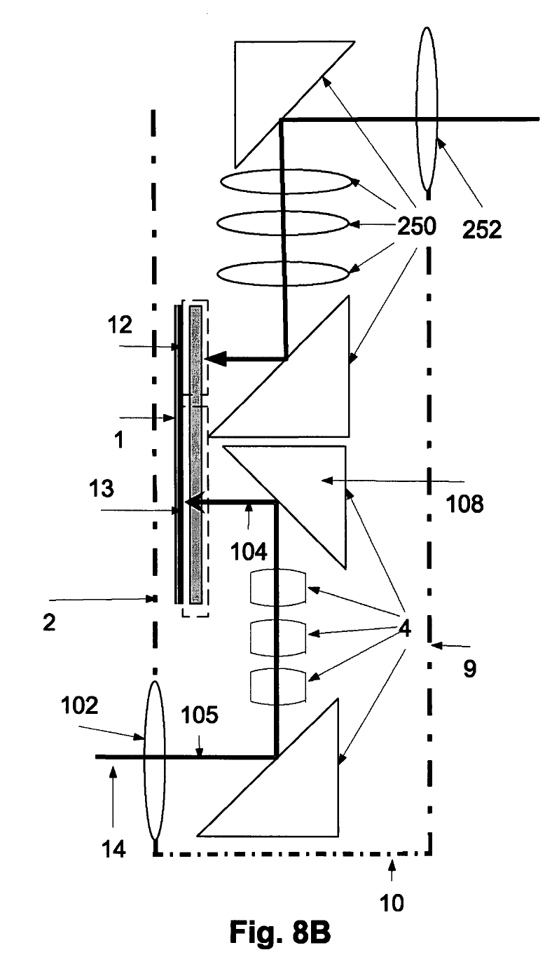

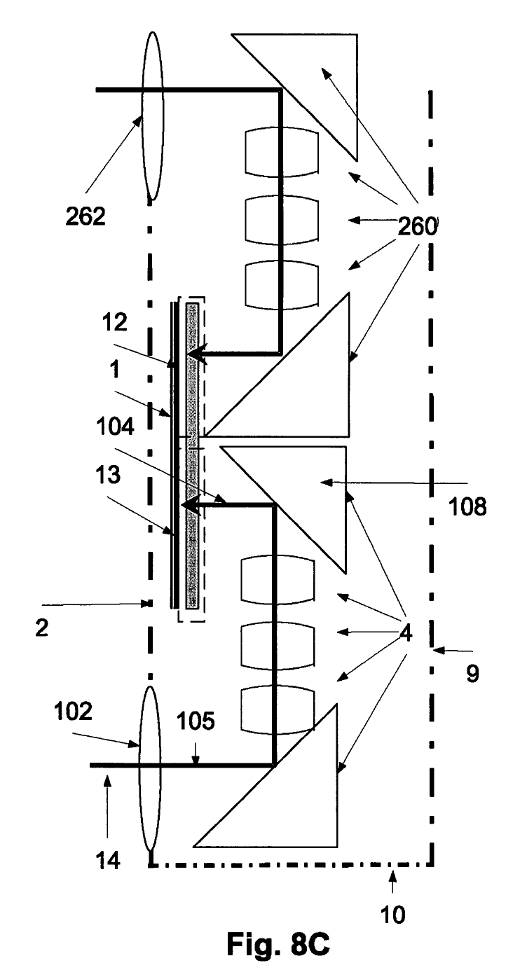

Reference is now made to FIG. 8A, which is a sectional illustration of a section of the mobile communication terminal 11 having the folded imaging unit 4 of FIG. 7B and a linear imaging unit 200, according to one embodiment of the present invention. As described above, the image sensor 1 may be divided to two or more regions, for example as shown at 12 and 13. Images captured by different imaging units, for example as shown at 4 and 200, are separately and optionally simultaneously projected on each one of the regions, optionally in a similar manner to the image projection that is described in FIG. 6.

Optionally, the mobile communication terminal 11 is a mobile phone. As depicted in FIG. 8A, the image pick-up elements 201, 102 are situated in opposite sides. In such an embodiment, the user may capture simultaneously, using a single image sensor 1, an image of herself and of the scenery in front her. In use, the mobile communication terminal 11 with the imaging system that is depicted in FIG. 8A may allows the user to capture an image of her face using the image pick-up element that is shown at 201 while simultaneously capturing the scenery in front her using the image pick-up element that is shown at 102. In such a manner, a user may use the mobile communication terminal 11 to simultaneously capturing her face and another person or object, optionally during a video conference or call.

As depicted, the optical axis of the nonlinear imaging unit 4 is folded, at least in two sequential turns 108, 107. Optionally, one of the regions 12 is allocated to the imaging unit, which is shown at 200, and another region 13, preferably larger, is allocated for the imaging unit that is shown at 4.

Reference is now made to FIG. 8B, which is a sectional illustration of a section of the mobile communication terminal having the folded imaging unit 4 of FIG. 7B and an additional folded imaging unit 250, according to one embodiment of the present invention. Images captured by the folded imaging units 4, 250, are separately and optionally simultaneously projected on each one of the regions 12, 13 optionally in a similar manner to the image projection that is described in FIG. 6.

In the embodiment that is depicted in FIG. 8B, similarly to the embodiment that is depicted in FIG. 8A, the image pick-up elements 252, 102 are situated in opposite sides. In such a manner, the user may capture simultaneously, using a single image sensor 1, an image of herself and of the scenery in front her using folded imaging units 4 that may have relatively long optical axis, as described above.

Reference is now made to FIG. 8C, which is a sectional illustration of a section of the mobile communication terminal having the folded imaging unit 4 of FIG. 7B and an additional folded imaging unit 260 with a receiving element 262, according to one embodiment of the present invention. Images captured by the folded imaging units 4, 260, are separately and optionally simultaneously projected on each one of the regions 12, 13. In the embodiment that is depicted in FIG. 8C, the image pick-up elements 262, 102 are situated in the same side of the mobile communication terminal. Optionally, each one of the folded imaging units 4, 260 projects an image on a respective half of the image sensor 1. Optionally, the image sensor 1 has a height half as much as the height of an image sensor with a similar receiving area and a single imaging unit. In such a manner, image sensor 1 captures an image with the same resolution as image sensors with twice as much height and a single imaging unit. Optionally, the image sensor may be divided to more than two regions, which are projected by more than two optic units. In such a manner, the height of the image sensor 1 may be at least two times less than the height of an image sensor with the same receiving area and a single imaging unit. Optionally, the regions are projected with overlapping images. Optionally, the regions overlap and preferably process sequentially. Optionally, the folded imaging units 4, 260 share optic elements, such as an image-diverting element and/or a converging lens. Optionally, the

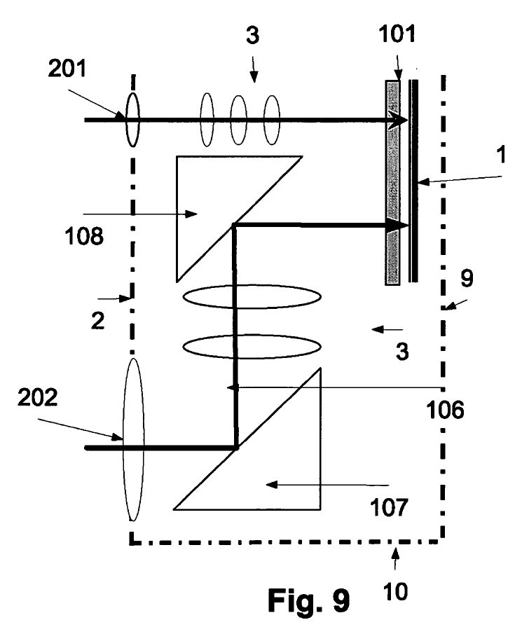

Reference is now made to FIG. 9, which is a sectional illustration of a section of the mobile communication terminal 11 having the linear imaging unit 3 that is depicted in FIG. 6 and an additional imaging unit 300 with a folded optical axis, according to one embodiment of the present invention. As described above, an imaging unit with a folded optical axis, for example as shown at 4, has a longer focal length and more zoom power than an imaging unit with unfolded optical axis, for example as shown at 3. As described above, the image sensor 1 is divided to two or more regions, for example as shown at 12 and 13. The linear imaging unit 3 projects an image on a first region 12 and the folded imaging unit 4 projects an image on a second region 13. In the embodiment that is depicted in FIG. 5, the image pickup elements 201, 203 of the imaging units 3, 4 are directed to a common direction. In such an embodiment, the image sensor 1 is used, optionally simultaneously, for capturing the same scene using different imaging units. For example, two or more imaging units, each with a set of lenses with a different focal length, a different frame size, or another variable optical property, may be used for capturing a common scene, optionally simultaneously. In such a manner, the same scene may be captured with different resolution, focus, and/or zoom, allowing the user to provide a more extensive depiction thereof. For example, the user may capture simultaneously a close-up and a long shot of a friend or the like.

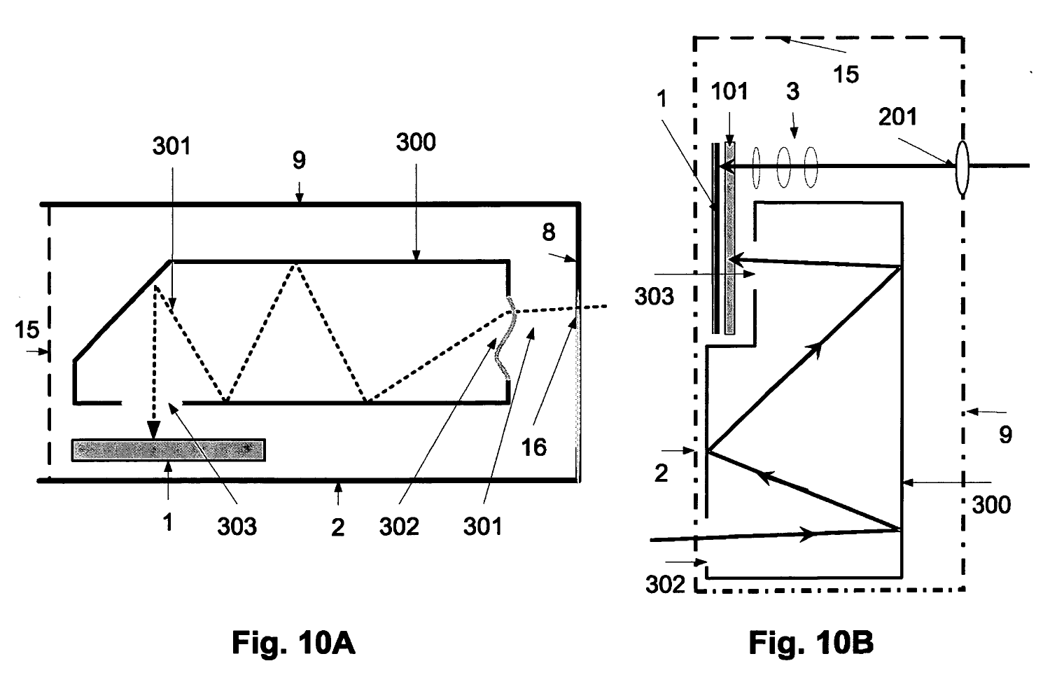

Reference is now made to FIG. 10A, which is a sectional illustration of a section of the mobile communication terminal 11 having a linear image-guiding unit 300 with a folded optical axis 301, according to one embodiment of the present invention. The linear image-guiding unit 300 is designed to guide light that forms an image from an image-capture aperture 302 to an exit aperture 303, via a linear folded optic axis, as shown at 301.

The linear image-guiding unit 300 is a single block with light incident surfaces. The single block may be a monoblock of transparent glass or layers of glass which are adhered to one another. The single block is made of a material with relatively high transparency level, such as the transparency level of a single block crystal or glass. Optionally, the linear image-guiding unit 300 is made of transparent polycarbonate, such as LEXAN™, or glass, such as MBACD12 of Hoya™ Corporation or BK-7 optical glass. As the linear image-guiding unit 300 is made of a transparent material, the image is not obscured and therefore the modulation transfer function (MTF) values of the linear image-guiding unit 300 are not reduced. Optionally, the linear image-guiding unit 300 is shaped with a light incident surface that bend and focus the light in a linear folded optical axis, for example as shown at 301, or with a number of light incident surfaces, as shown at FIGS. 10A-10B. Each one of the light incident surfaces may be planar, spherical or aspheric. Optionally, the light incident surfaces are situated in niches of the linear image-guiding unit 300, which are curved to divert the optical axis in a desired direction.

Optionally, the image-capture aperture 302 functions as a diverting element that diverts incoming light toward a light incident surface in the linear image-guiding unit 300. In such a manner, the incoming light travels in a folded optical axis, as shown in FIGS. 10A-10B. Optionally, the image-capture aperture 302 is curved, coated, and/or machined in a manner that diverts or processes the incoming light to travel toward a certain light incident surface, for example as depicted in FIG. 10A.

Optionally, the folded optical axis 301 is designed to pass via the image-capture aperture 8 that is optionally situated in parallel to the vertical axis 15 of the mobile communication terminal, similarly to the folded optical axis that is depicted in FIG. 3. As described above, the optics of the folded imaging unit 4 allows the positioning of the image sensor 1 in a parallel to the vertical axis 15 of the mobile communication terminal, for example as shown at FIG. 3. In such a manner, the image sensor 1 may be mounted in parallel to the rear or front sides of the mobile communication terminal.

A light incident surface may be understood as a light diverting surface, a reflective surface, a catadioptric surface, a refractive surface or a diffractive surface or partially diffractive. Optionally, the light incident surface is used for processing the light, for example by focusing the light that forms the image conveyed in the optical axis. Optionally, the light incident surface is a MEMS mirrors unit, which is used to reflect, refract, or diffract the image. In such an embodiment, the MEMS mirrors unit may be used for bouncing beam lights that that travel on the optical axis 301. The mirrors of the MEMS mirrors unit may be tilted to deflect the light beams to different points in the linear image-guiding unit 300. Optionally, adaptive optics technology is used, optionally with the MEMS mirrors unit, to improve the performance of folded imaging unit 4 by reducing effects of rapidly changing optical distortions. In such an embodiment, the MEMS mirrors unit of imaging unit 4 is adapted to compensate for optical effects, such as optical effects, which are introduced by a medium between the image sensor 1 and the captured image or for disadvantages or malfunctions of the image sensor 1. Optionally, the MEMS mirrors unit is used for calibration.

Optionally, the MEMS mirrors unit is used for focusing the image that is projected on the image sensor 1 by focusing the light that is conveyed on the optical axis or to for changing the overall magnification of the linear image-guiding unit 300 by altering the size of a beam of light that travels on the optical axis 301.

Optionally, the linear image-guiding unit 300 is shaped with an image-capture aperture, for example as shown at 302, and with an exit aperture, for example as shown at 303. Light that enters via the image-capture aperture 302 is reflected from one surface to another and leaves the linear image-guiding unit 300 via the exit aperture 303, toward a region in the image sensor 1. Optionally, the linear image-guiding unit 300 is 4 mm thick and the optical axis thereof is 12 mm long.

Reference is now made to FIG. 10B, which is a sectional illustration of a section of the mobile communication terminal 11 having the linear imaging unit 3 that is depicted in FIG. 6 and the linear image-guiding unit 300 of FIG. 10A, according to one embodiment of the present invention. In the embodiment that is depicted in FIG. 10B, the linear image-guiding unit 300 comprises a plurality of diverting surfaces that divert the optical axis within the linear image-guiding unit 300.

As depicted in FIG. 10B, a portion of the component imaging unit 300 and the image sensor 1 are optionally situated on a common plane that is parallel to a side of the mobile communication mobile 11 to which the image sensor 1 is attached, for example as shown at 2. In such an embodiment, all the depth of the linear image-guiding unit 300 along the vertical axis, as shown at 15, is utilized for extending the folded optical axis of the imaging unit 300.

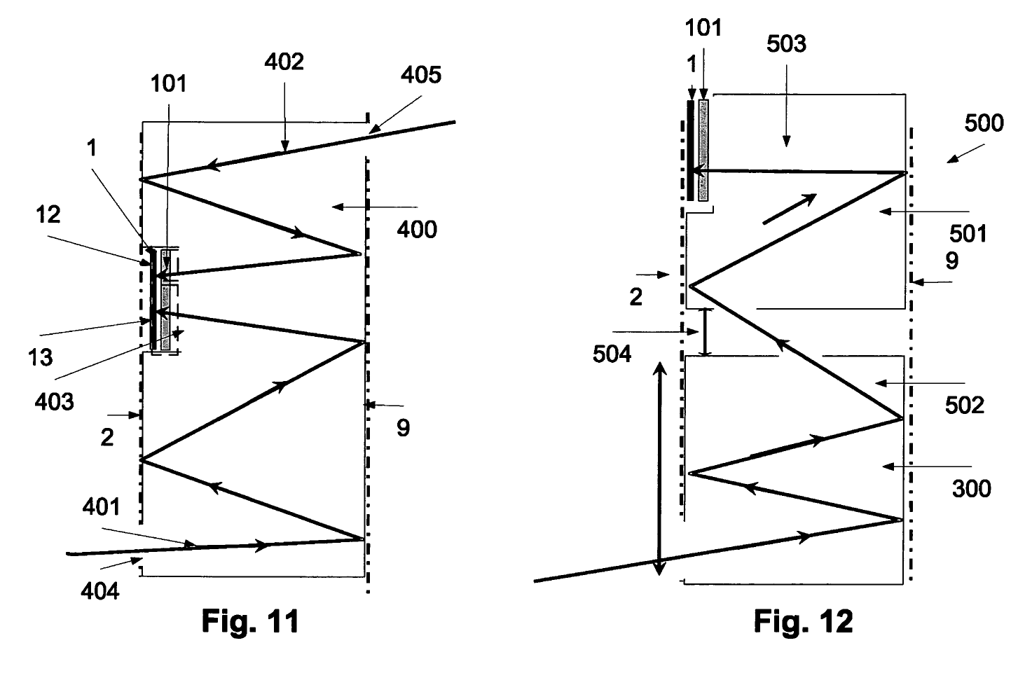

Reference is now made to FIG. 11, which is a sectional illustration of a section of the mobile communication terminal 11 having a linear image-guiding unit 400, according to one embodiment of the present invention. The image sensor 1 and the linear image-guiding unit 400 are substantially as in FIG. 10B. However, unlike the linear image-guiding unit of FIG. 10B, the linear image-guiding unit 400 has two folded optical axis 401, 402, which are extended from two different image-capture apertures 404, 405 to terminate at a common exit aperture, as shown at 403 or two exit apertures, which are situated in parallel to the same plane. In such an embodiment, the linear image-guiding unit 400 projects different images on two different regions 12, 13 of the image sensor 1. The different image-capture apertures 404, 405 may be situated on the same side of the linear image-guiding unit 400 or on different sides of the linear image-guiding unit 400, for example as depicted in FIG. 11. The image-capture apertures 404, 405 are situated in of sides of the mobile communication terminal 11, which are opposite to one another.

Optionally, the linear image-guiding unit 400 defines the extending of two or more optical axes from a respective number of image-capture apertures to terminate at a common or different exit apertures.

Optionally, the optical axes, for example 401, 402, are directed to different image sensors.

Reference is now made to FIG. 12, which is a sectional illustration of a section of the mobile communication terminal 11 having a mechanical assembly 500 with two linear image-guiding units 501, 502, according to one embodiment of the present invention. The image sensor 1 and the linear image-guiding unit 501 are substantially as in FIG. 10B. However, unlike the linear image-guiding unit of FIG. 10B, the mechanical assembly 500 comprises two linear image-guiding units 501, 502, which are designed to guide jointly an image via a common optical axis, as shown at 503. Optionally, the additional linear image-guiding unit 502 is a movable unit.

The mechanical assembly 500 has the ability to change a distance 504 between the linear image-guiding units 501, 502. Such ability may be used for changing the focal length, focusing the image that is projected on the image sensor 1, optionally by focusing the image that is conveyed in the optical axis, and/or changing the overall magnification of the linear image-guiding units 501, 502 by altering the size of a beam of light that travels on the optical axis. The mechanical assembly 500 that is depicted in FIG. 12 may be used for projecting an image on the entire image sensor 1 or only on a section thereof. Optionally, the mechanical assembly 500 is used together with an additional imaging unit that projects another image on the entire image sensor 1 or only on a region thereof.

Though the embodiment which are depicted in FIGS. 1-12 and the related text which is provided hereinabove are related to handhelds with an image sensor, the embodiments the present invention are further related to handhelds with projectors. In such embodiments, a projecting unit is situated instead or in addition to the image sensor and the light that travels via the aforementioned optical axes travels on the opposite direction. Optionally, the projecting unit comprises a digital micro-mirror device (DMD) that produces the image to be projected. It should be noted that a projecting unit with a number of projecting elements may be used in place of an image sensor with a number of receiving regions, similarly to the described above.

It is expected that during the life of this patent many relevant devices and systems will be developed and the scope of the terms herein, particularly of the terms optical element, a path-diversion element, and are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A mobile communication terminal, comprising:
a body having a minimum bounding box with a wide dimension, said body comprising an image-capture aperture substantially perpendicular to said wide dimension;
an image sensor, situated in said body; and
an imaging unit, situated in said body, configured for imaging an image captured via said image-capture aperture on said image sensor.

2. The mobile communication terminal of claim 1, wherein said minimum bounding box having longitudinal, lateral, and vertical axes and a plurality of sides, said body being thinner along said vertical axis than along said lateral and longitudinal axes, at least one of said plurality of sides being situated substantially in a plane parallel to said vertical axis and having said image-capture aperture.

3. The mobile communication terminal of claim 1, wherein said imaging unit comprises at least one wide field of view (WFOV) lens.

4. The mobile communication terminal of claim 1, wherein the dimensions of said imaging unit being at least twice along said wide dimension than in parallel to said image-capture aperture.

5. The mobile communication terminal of claim 1, wherein said image has a width at least twice a height thereof.

6. The mobile communication terminal of claim 1, wherein said image sensor is substantially parallel to said wide dimension.

7. The mobile communication terminal of claim 6, wherein said image sensor and at least a portion of said imaging unit are situated in a common plane being substantially parallel to said wide dimension.

8. The mobile communication terminal of claim 7, wherein said image sensor comprises a processing circuitry configured for processing said image and situated in said common plane.

9. The mobile communication terminal of claim 1, wherein said imaging unit has a linear optic axis, a receiving side of said imaging device being substantially parallel to said image-capture aperture.

10. The mobile communication terminal of claim 1, wherein said imaging unit having a folded optic axis.

11. The mobile communication terminal of claim 1, wherein said image sensor having a receiving side with first and second receiving regions, said imaging unit being configured for imaging said image on said first receiving region, said image depicting a first scene.

12. The mobile communication terminal of claim 11, further comprising an additional imaging unit for imaging an additional image of a second scene on said second receiving region.

13. The mobile communication terminal of claim 11, wherein said first and second scenes depict adjacent scenes.

14. The mobile communication terminal of claim 13, wherein said image sensor is configured for outputting a third image depicting said adjacent scenes.

15. The mobile communication terminal of claim 12, wherein said additional image is captured via said image-capture aperture.

16. The mobile communication terminal of claim 12, wherein said additional image is captured via an additional image-capture aperture being situated in a parallel to said wide dimension.

17. The mobile communication terminal of claim 1, wherein the mobile communication terminal is a member of the following group: a mobile phone, a dual-mode phone, and a personal digital assistant (PDA).

18. The mobile communication terminal of claim 1, wherein said imaging unit comprising a path-diversion element, said imaging being performed via said path-diversion element.

19. The mobile communication terminal of claim 18, wherein said path-diversion element comprises a member of the following group: a reflective element, a refractive element, and a diffractive element.

20. The mobile communication terminal of claim 18, said path-diversion element is a micro-electromechanical system (MEMS) mirrors unit.

21. The mobile communication terminal of claim 1, wherein said imaging unit comprises a single block of a transparent material, said imaging being performed by guiding said image from said image-capture aperture to said image sensor in a folded optical axis formed in said single block.

22. The mobile communication terminal of claim 21, wherein said imaging unit comprises a plurality of light incident surfaces facing said single block, said folded optical axis being defined by said light incident surfaces.

23. The mobile communication terminal of claim 22, wherein at least one of said plurality of light incident surfaces is situated in at least one niche in said single block.

24. The mobile communication terminal of claim 1, wherein said imaging unit comprises a mechanical assembly having first and second single blocks of a transparent material, said imaging being performed by guiding said image from said image-capture aperture to said receiving element in a folded optical axis formed in said first and second single blocks.

25. The mobile communication terminal of claim 24, wherein said mechanical assembly is configured to apply an optical effect on said folded optical axis by moving at least one of said first and second single blocks.

26. The mobile communication terminal of claim 25, wherein said optical effect is a member of the following group: changing the focal length of said folded optical axis and changing the overall magnification of said folded optical axis.

27. The mobile communication terminal of claim 10, wherein said imaging unit comprises a single block of a transparent material, said imaging being performed by guiding said image from said image-capture aperture to said receiving element in a folded optical axis formed in said single block, said single block being configured for imaging a second image of a second scene on said second receiving region.

28. The mobile communication terminal of claim 11, wherein said first and second scenes are on opposite sides of the mobile communication terminal.

29. The mobile communication terminal of claim 18, wherein an acute angle formed between first and second rays sharing a common endpoint on said path-diversion, said first and second rays respectively passing through the centers of said image sensor and said image-capture aperture.

30. The mobile communication terminal of claim 1, wherein said imaging unit comprises a diverted lens, said diverted lens being situated in said image-capture aperture and mounted in an acute angle in relation to a perpendicular to said wide dimension.

31. The mobile communication terminal of claim 1, wherein said wide dimension comprises a screen.

32. The mobile communication terminal of claim 31, wherein said screen is configured to have a viewing angle for watching said image that allows a user of the mobile communication terminal to watch clearly said image during the capturing thereof from a point of view (POV) of more than 30° degrees from the center of said screen.

33. The mobile communication terminal of claim 31, wherein said screen is an adjustable screen, the viewing angle of said adjustable screen in relation to a plane of side front side being determined by a user of the mobile communication terminal.

34. The mobile communication terminal of claim 1, wherein said body comprises first and second sections and a hinge for foldably coupling said first and second sections, said image sensor and said imaging unit being situated in one of said first and second sections.

35. A handheld device, comprising:
an image sensor having a receiving element facing a first side of said handheld device; and
an imaging unit having an image pick-up element directed toward a second side opposing said first side, said imaging unit being configured for imaging an image taken using said image pick-up element on said image sensor.

36. The handheld device of claim 35, wherein said imaging unit is fixated to a body of said handheld device.

37. The handheld device of claim 35, wherein said image sensor and said image pick-up element are placed in a common plane being parallel to a side of the handheld device.

38. The handheld device of claim 35, wherein said receiving element has first and second receiving regions, said imaging unit being configured for imaging said image on said first receiving region.

39. The handheld device of claim 38, further comprising a second imaging unit for imaging a second image of a second scene on said second receiving region.

40. The handheld device of claim 39, wherein said second image is captured using a second image pick-up element that is substantially perpendicular to said image pick-up element.

41. The handheld device of claim 39, wherein said second image is captured using a second image pick-up element, and wherein said first and second image pick-up elements facing opposing directions.

42. The handheld device of claim 39, wherein said first and second images are simultaneously imaged on said image sensor.

43. The handheld device of claim 35, wherein said imaging unit comprising a path-diversion element, said imaging being performed via said path-diversion element.

44. The handheld device of claim 35, wherein said imaging unit comprises a single block of a transparent material, said imaging being performed by guiding said image from said image pick-up element to said receiving element in a folded optical axis formed in said single block.

45. The handheld device of claim 35, wherein 2, wherein said imaging unit comprises at least one wide field of view (WFOV) lens.

46. A handheld device, comprising:
an image sensor having a receiving element facing a first side of said handheld device; and
an imaging unit having a path-diversion element configured unit for imaging an image of a scene on said receiving element;
wherein an angle formed between first and second rays sharing a common endpoint on said path-diversion element is less than 45° degrees, said first and second rays respectively passing through said image sensor and the center of said scene.

47. A mobile communication terminal, comprising:
an image sensor having a receiving side; and
a screen configured for displaying an output of said image sensor;
wherein said receiving side and said screen are substantially perpendicular to one another.

48. The mobile communication terminal of claim 47, further comprising a body, said image sensor fixed in parallel to a first side of said body, said screen fixed to a second side of said body, said first and second sides are perpendicular to one another.

49. The mobile communication terminal of claim 47, wherein said screen having a viewing angle for watching said output, said viewing angle allowing a user of the mobile communication terminal to watch clearly said output during the capturing thereof from a point of view (POV) of more than 30° degrees from the center of said screen.

50. The mobile communication terminal of claim 47, wherein said screen is an adjustable screen, the viewing angle of said adjustable screen in relation to a plane of side front side being determined by a user of the mobile communication terminal.

51. A mobile phone for projecting an image, comprising:
a body having a minimum bounding box with a wide dimension, said body comprising an image projecting aperture substantially perpendicular to said wide dimension;
a projecting unit, situated in said body; and
an imaging unit, situated in said body, for guiding an image projected by said projecting unit via said image-capture aperture.

52. The mobile phone of claim 51, wherein said body having longitudinal, lateral, and vertical axes and a plurality of sides, said body being thinner along said vertical axis than along said lateral and longitudinal axes, at least one of said plurality of sides being situated substantially in a plane parallel to said vertical axis and having said image-capture aperture.
